(19) United States
(12) Patent Application Publication
(10) Pub. No.: US 2020/0187274 A1
(43) Pub. Date: Jun. 11, 2020

(54) LEVERAGING RECEPTION TIME IN CONNECTION WITH IDENTIFICATION IN A WIRELESS COMMUNICATION SYSTEM

(71) Applicant: Telefonaktiebolaget LM Ericsson (publ), Stockholm (SE)

(72) Inventors: Johan RUNE, Lidingö (SE); Johan AXNÄS, Solna (SE); Icaro L. J. DA SILVA, Solna (SE); Andres REIAL, Malmö (SE); Henrik SAHLIN, Mölnlycke (SE)

(21) Appl. No.: 16/311,280

(22) PCT Filed: Sep. 26, 2016
(86) PCT No.: PCT/SE2016/050911

§ 371 Date: Dec. 19, 2018

(51) Int. Cl. H04W 76/11; H04L 5/00; H04W 16/28; H04B 7/06; H04W 56/00

(52) U.S. Cl. CPC H04W 76/11; H04L 5/0051; H04W 56/001; H04B 7/0617; H04W 16/28

(57) ABSTRACT

The present disclosure relates to reporting in mobile communications. More specifically, the proposed technique relates to reporting and obtaining an identity using reference signals to represent the identity. The disclosure also relates to corresponding devices and to a computer program for executing the proposed methods. The disclosure proposes a method, for use in a wireless device, for obtaining an identity. The method includes receiving a reference signal, estimating a reception time of the received reference signal and obtaining, identity information based on the received reference signal, the identity information in combination with the estimated reception time indicating the identity.

### TECHNICAL FIELD

The present disclosure relates to reporting in mobile communications. More specifically, the proposed technique relates to reporting and obtaining an identity using reference signals to represent the identity. The disclosure also relates to corresponding devices and to a computer program for executing the proposed methods.

### BACKGROUND

The 3rd Generation Partnership Project, 3GPP, is responsible for the standardization of the Universal Mobile Telecommunication System, UMTS, and Long Term Evolution, LTE. The 3GPP work on LTE is also referred to as Evolved Universal Terrestrial Access Network, E-UTRAN. LTE is a technology for realizing high-speed packet-based communication that can reach high data rates both in the downlink and in the uplink and is thought of as a next generation mobile communication system relative to UMTS. In order to support high data rates, LTE allows for a system bandwidth of 20 MHz, or up to 100 MHz when carrier aggregation is employed. LTE is also able to operate in different frequency bands and can operate in at least Frequency Division Duplex, FDD, and Time Division Duplex, TDD, modes.

In an UTRAN and an E-UTRAN, a User Equipment, UE, i.e. a wireless device, is wirelessly connected to an access node or Radio Base Station, RBS, commonly referred to as a NodeB, NB, in UMTS, and as an evolved NodeB, eNodeB or eNB, in LTE. A Radio Base Station, RBS, or an access node is a general term for a radio network node capable of transmitting radio signals to a wireless device and receiving signals transmitted by a wireless device. In Wireless Local Area Network, WLAN, systems the wireless device is also denoted as a Station, STA.

In the future communication networks, also referred to as the 5th generation mobile networks, there will be evolvement of the current LTE system to the so called 5G system. Due to the scarcity of available spectrum for future mobile, wireless communication systems, spectrum located in very high frequency ranges (compared to the frequencies that have so far been used for wireless communication), such as 10 GHz and above, are planned to be utilized for future mobile communication systems.

For such high frequency spectrum, the atmospheric penetration and diffraction attenuation properties can be much worse than for lower frequency spectrum. In addition, the receiver antenna aperture, as a metric describing the effective receiver antenna area that collects the electromagnetic energy from an incoming electromagnetic wave, is frequency dependent, i.e., the link budget would be worse for the same link distance even in a free space scenario, if omnidirectional receive and transmit antennas are used. This motivates the usage of beamforming to compensate for the loss of link budget in high frequency spectrum.

Hence, future communications networks are expected to use advanced antenna systems to a large extent. With such antennas, signals will be transmitted in narrow transmission beams to increase signal strength in some directions, and/or to reduce interference in other directions. The beamforming will enable high data rate transmission coverage also to very distant users which would not realistically be covered with normal sector-wide beams, which have lower antenna gain. Beamforming may be used at the transmitter, at the receiver, or both. In a large part of the spectrum planned for 5G deployments the preferred configuration is to use a large antenna array at the access node and a small number of antennas at the wireless device. The large antenna array at the access node enables high-order transmission beamforming in the downlink.

Whenever handover is performed in such a system, for example from one access node to another, or from one frequency band to another, then a good beam direction at the handover target (i.e. the new access node or the new carrier frequency) towards the wireless device needs to be found in order to sustain high data rate transmission. Furthermore, in systems with very high-gain narrow beamforming, even just performing synchronization or exchanging some initial control signaling messages at the handover target may require selection of a sufficiently good beam direction in order for the access node and the wireless device to hear each other sufficiently well.

The procedure of sequentially transmitting the beam in all necessary directions is referred to as a beam sweep or beam scan. A beam sweep may consist of a variable number of beams depending on the situation. Often, quite many beams may be required, especially when the candidate beams originate from multiple candidate access nodes.

However, when the number of beams in the sweep is substantial also this method runs into problems due to that each beam in a sweep typically has to be mapped to a specific reference signal, in order for the wireless device to be able to identify a beam in the sweep that was perceived as the best or in order to identify a time for responding to the beam. That makes reference signals a scarce resource and a potential limiting factor for the beam sweep, which in turn may hamper the handover performance. This problem might also occur in other situations when dissimilar reference signals are used to report one of plurality of identities to a network.

### SUMMARY

An object of the present disclosure is to provide methods and devices which seek to mitigate, alleviate, or eliminate one or more of the above-identified deficiencies in the art and disadvantages singly or in any combination and to provide a way to provision contextual data without need to allocate additional resources.

This object is obtained by a method, for use in a wireless device, for obtaining an identity. The method comprises receiving a reference signal, estimating a reception time of the received reference signal and obtaining, identity information based on the received reference signal, wherein the identity information in combination with the estimated reception time indicates the identity. The proposed solution reduces the number of unique reference signals comprising unique reference signal sequences that are needed to indicate an identity, by enabling/facilitating efficient reuse of such sequences.

The reduction of the number of needed unique reference signal sequences also allows selection of reference signal sequences of higher quality in terms of autocorrelation and cross-correlation properties (since sequences with good such properties is a limited resource). Furthermore, the processing burden on the wireless device is eased. When the number of possible reference signal sequences that the wireless device has to search for (i.e. try to decode) is drastically reduced, the wireless device's processing burden is also reduced.

According to some aspects, the identity is an identity associated with any one or more of; a beam, a beam direction, a reception time and/or a transmission time. Hence, if the identity is associated with a beam in a beam sweep, the number of unique reference signal sequences that are needed for a beam sweep in conjunction with handover or initial access is reduced, by enabling/facilitating efficient reuse of such sequences.

According to some aspects, the identity information specifies a time within a reuse period, wherein the time indicates when within the reuse period the respective reference signal was transmitted. In other words, the only information that needs to be signalled in order to provide an accurate time synchronisation is a time within a reuse period, i.e. a granular time component.

According to some aspects, the method comprises obtaining the duration of the reuse period and determining the identity based on identity information, the estimated reception time and the obtained reuse period. For example, the method enables determining an exact time, which is then mapped to the identity.

According to some aspects, the method comprises reporting the identity information and the estimated reception time to a network node. Hence, the actual determination of the identity might be performed in the wireless device or in the network.

According to some aspects, the disclosure proposes a method for use in a network node, for providing an identity, to one or more wireless devices. The method comprises determining one or more reference signals, such that each reference signal indicates identity information, whereby each reference signal in combination with an estimated reception time of the reference signal, enables determination of the identity; and initiating transmission of the reference signals to the one or more wireless devices, at different points in time.

According to some aspects, the disclosure proposes a network node in a communication network configured for providing an identity to one or more receiving wireless devices. The network node comprises a communication interface and processing circuitry configured to cause the network node to determine multiple reference signals, such that each reference signal indicates identity information, whereby each reference signal in combination with an estimated reception time of the reference signal, enables determination of the identity. The processing circuitry configured to cause the network node to initiate transmission of the reference signals to the one or more wireless devices, at different points in time.

According to some aspects, the disclosure proposes a computer program comprising computer program code which, when executed in a wireless device, causes the wireless device to execute the methods described below and above.

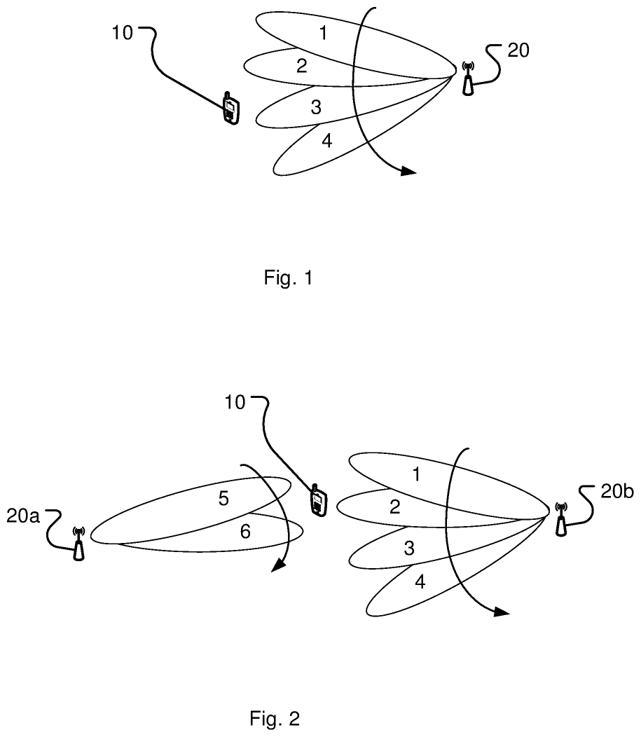

FIG. 1 illustrates a beam sweep transmitted from a network node having one transmission point.

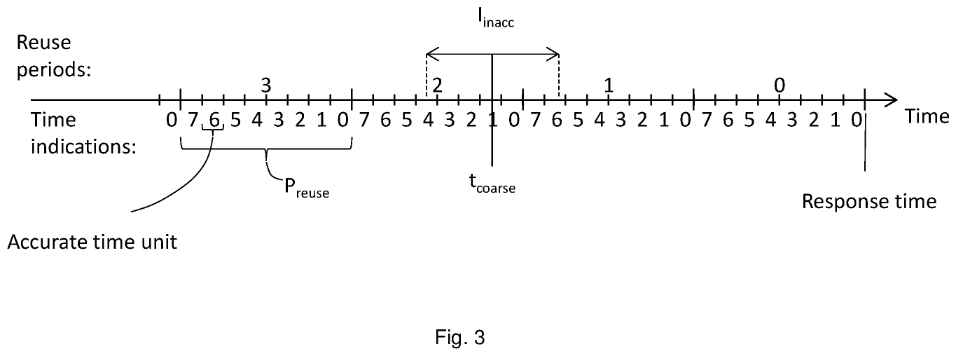

FIG. 2 illustrates a beam sweep transmitted from two separate transmission points.

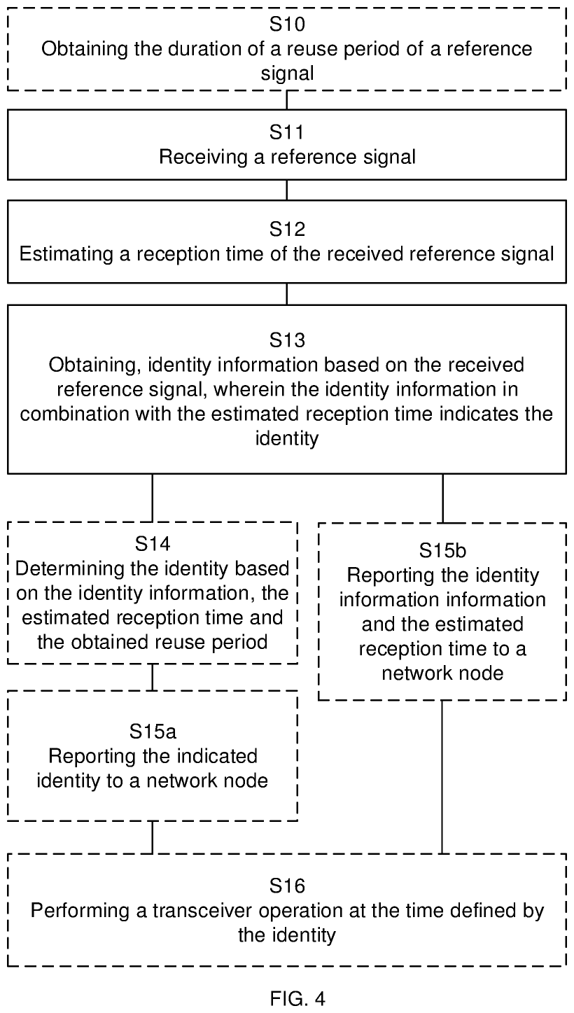

FIG. 3 illustrates how time can be divided into full accuracy and coarse accuracy intervals/units.

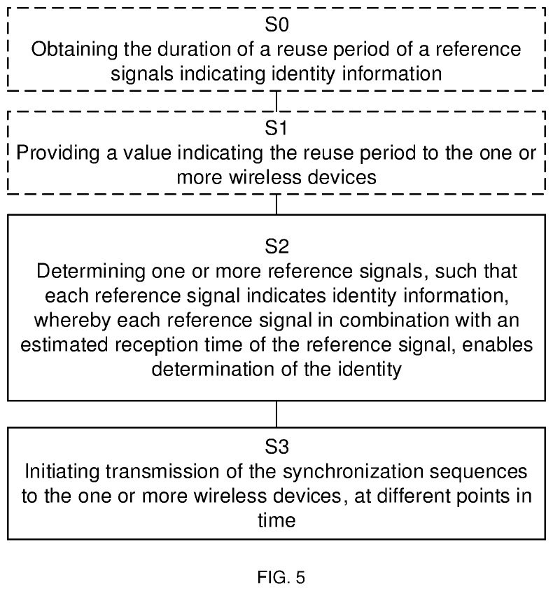

FIG. 4 is a flowchart illustrating method steps performed in a wireless device according to the proposed technique.

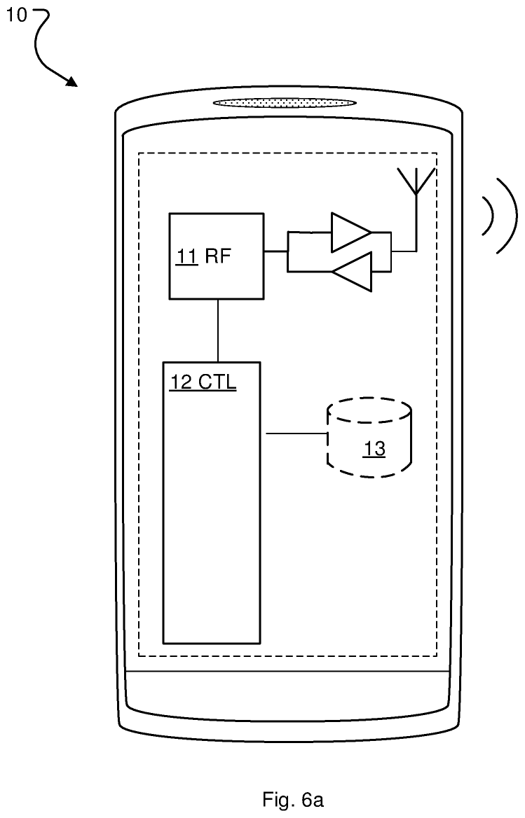

FIG. 5 is a flowchart illustrating method steps performed in a network node according to the proposed technique.

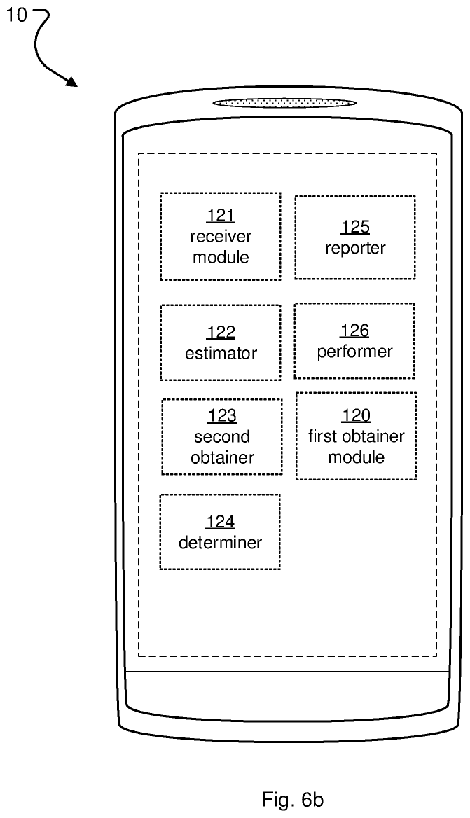

FIGS. 6a and 6b is an example node configuration of a wireless device, according to some of the example embodiments.

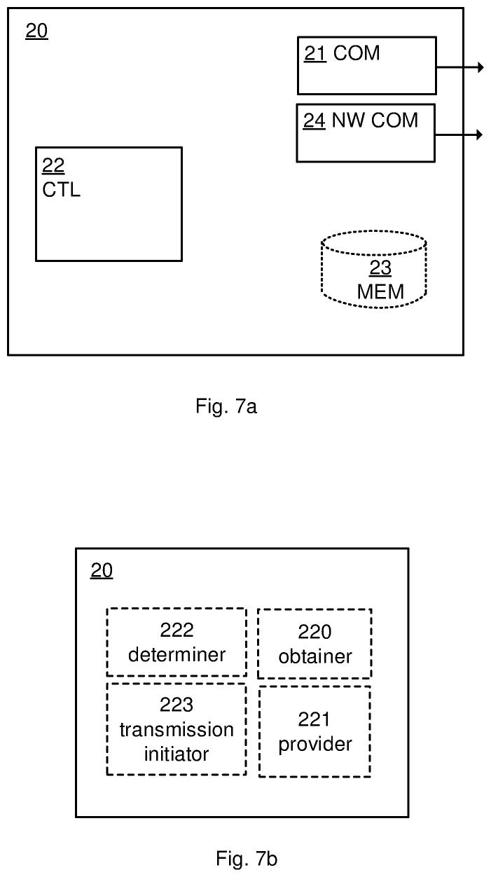

FIGS. 7a and 7b is an example node configuration of a network node, according to some of the example embodiments.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

The proposed technique is based on the idea to utilize an estimation of the reception time of a reference signal in a wireless device as an additional parameter when one unique identity of a plurality of possible identities is to be provided to a wireless device in a wireless communication network.

A reference signal herein refers to a pre-defined signal, which is known to both transmitter and receiver. The reference signal is typically characterized by a certain symbol or symbol sequence. The receiver monitors the radio channel for this pre-known symbol or symbol sequence (i.e. a sequence of one or more symbols) and when a match is found the reference signal is detected. A symbol sequence used in a reference signal is herein referred to as a reference signal sequence. As stated above, reference signals are sometimes used to identify some entity, such as individual beams in a beam sweep. If only the reference signal is used for this purpose, each beam in the sweep needs to be assigned to a unique reference signal sequence.

By using the time estimation, even if it is coarse, the unique identity can be represented by a reduced number of unique symbols or sequences, whereby signaling is reduced and the number of required unique identifiers, e.g. sequences or symbols included in the reference signals, which may be a scarce resource, is also reduced. The idea is based on the insight that even if the synchronization is only rough, it may still be utilized.

One example of such a unique identity to be provided is an identity associated with a beam in a beam sweep as discussed above. When reporting a beam sweep, the wireless device typically needs to be able to uniquely identify each single beam in the beam sweep. Traditionally this has been done using the reception time for the beam to identify the beam. However, this requires that all beams are separated in time and that the time synchronization is accurate. An alternative is, as mentioned above to map one unique reference signal to each beam. However, as mentioned above, this is problematic, when the number of beams increases.

This disclosure will use the example of beam reporting for describing the proposed solution. Hence, for better understanding of the proposed technique a short introduction to beam sweeping procedures foreseen to be used in the next generation communication systems will now be given.

In order for the initial-access procedure not to be the coverage-limiting factor in the next generation of communication systems, the reference signals used for synchronization and mobility will typically also have to use high-gain narrow beams. This means that the access node will typically have to transmit the signals multiple times, in different directions, to cover the geographical area to be served by an access node, AN. With typical antenna configurations envisioned for the next generation communication systems, sometimes referred to as 5G systems, a narrow beam may cover only a small fraction of the entire geographical area (e.g. 1%) at a time, and consequently it may take substantial time to transmit the beam in all directions needed, one or a few directions at a time.

The access node could in principle, depending on hardware configuration, transmit the reference signals in many directions at the same time, but given a maximum total output power of the access node, such simultaneous transmission would be at the expense of proportionally reduced power per beam, i.e. effectively reduce the coverage. This could be compensated for by over-dimensioning the hardware such that excessive total output power is available, but this would undesirably increase the cost of the equipment.

The procedure of sequentially transmitting the beam in all necessary directions is referred to as a beam sweep or beam scan. “Necessary directions” here means all directions where coverage is desired. FIG. 1 illustrates a beam sweep transmitted from a network node 20 having one transmission point. Such a beam sweeping procedure with the purpose of synchronization and beam finding may be performed both for initial access and in conjunction with handover of a wireless device from one beam to another. Note that a handover preparation procedure involving beam sweeping may involve activated candidate target beams from the wireless device's current serving access node and/or one or more other candidate target access nodes. In 5G systems it is also expected that one single access node might have several transmission points.

The wireless device may hear any of the many transmissions of the reference signal during the beam sweep, and the network will not know which one the wireless device heard. This means that if the wireless device is supposed to send a system access request, a certain time after hearing a synchronization beam transmission, which is a typical random access request procedure, then the network has to listen for an uplink signal at multiple time instances in a given direction, and/or the wireless device has to transmit its uplink signal at multiple time instances.

The beam sweep may serve other purposes than just time and frequency synchronization; in particular, the sweep may also serve the purpose of determining the best beam direction for data transmission to the new wireless device (accessing for the purpose of initial access or handover). In such cases, the beam may as mentioned above contain some information (e.g. a symbol sequence) that uniquely identifies the synchronization beam, so that the wireless device can report to the access node, which beam that was best received. A reference signal identifying a beam in a beam sweep is in 5G sometimes referred to as a Mobility Reference Signal, MRS or Beam Reference Signal, BRS.

Typically, a wireless device has been configured with the information it needs to determine the sequence number of a beam it wants to report, e.g. the best beam. This information may be e.g. the order in which the beams will be transmitted (in this case each beam would have a different Beam Reference Signals, BRS) or it may be information about in which time slots (or time windows) the beams will be transmitted in the sweep (e.g. “the N beams will be transmitted in time slots T, T+1, . . . T+N−1) (in this case no BRS is needed). In the former example the wireless device could map the BRS to a sequence number (i.e. beam number 5 in the sweep); in the latter example the wireless device could map the time slot where it received the beam (or rather when the beam was transmitted) to a sequence number (e.g. beam received in time slot T+4 that means it is beam number 5 in the sweep).

A wireless device that receives a beam sweep typically needs to respond by indicating the beam direction that is considered the “best”. A proposed way to realize beam reporting is that the wireless device sends a so called Uplink Synchronization Signal, USS, in the uplink towards the access node from which the selected (e.g. best) beam was received (or possibly to another access node or to multiple monitoring access nodes). The USS can indicate the selected beam by the time slot in which the USS is transmitted (a typical USS sequence may be 1, 2 or 3 OFDM symbols long). To support this mode of reporting a number of time slots (e.g. with a length of 1, 2 or 3 OFDM symbols each) have been configured, each mapping towards one of the beams in a so called beam sweep. An alternative way of USS based reporting is that there is only one reporting occasion (e.g. time slot) (possibly per candidate access node), but the symbol sequence used in the USS indicates the selected beam through a preconfigured mapping between USS sequence and beam (e.g. between USS and measured beam reference signal).

A USS may consist e.g. of a symbol sequence that is similar (or equivalent) to a random access preamble, e.g. a Zadoff-Chu sequence, or some other sequence with good autocorrelation and cross-correlation properties. USS based reporting, especially the alternative with a single reporting occasion and USS sequence to beam mapping, is preferable in many handover situations, because it is fast and transmission resource efficient and works even if the wireless device loses its connection with the old serving access node during the handover preparation (i.e. during the beam sweep).

A beam sweep may consist of a variable number of beams depending on the situation. Often, quite many beams may be required, especially when the candidate (downlink) beams originate from multiple candidate access nodes 20a, 20b, as shown in FIG. 2. In high frequency bands, where narrow beams may be required, the beams in a sweep may add up to a substantial number, especially when the wireless device's location is only vaguely known, e.g. when handing over a wireless device from a low to a high frequency band (and in general, in a handover situation between two downlink beams, which target downlink beam to activate may be quite uncertain).

The USS based beam sweep measurement reporting method that relies on the time slot of the USS transmission to indicate the selected beam becomes undesirably wasteful, because the candidate access nodes have to reserve a substantial number of uplink time slots for monitoring the allocated USS transmission time slots. In addition, since the wireless device may have to skip a number of time slots while waiting for the right one to transmit in (i.e. the time slot that corresponds to the beam that the wireless device is to report/indicate), the entire procedure may be prolonged and this may be emphasized because the AN may have to insert gaps in the beam reporting time slot sequence, due to other obligations, e.g. switching to downlink TDD operation. Note that an access node using Time Division Duplex, TDD, cannot transmit anything in the downlink while listening for uplink transmissions (and TDD is assumed to be the dominating operating mode for 5G in high frequency bands).

In light of the above problems of relying on time slots for beam indication in USS based reporting, the alternative USS based reporting method using the USS sequence to indicate the beam seems preferable. However, this reporting method is also not free from challenges. The source and target access nodes (and/or frequency bands in case of inter-frequency band handover) may be poorly synchronized; making configuration of the time to transmit the USS based report difficult. In the inter-access node case this is caused by the inter-access node synchronization inaccuracy. In the inter-frequency band case, where the wireless device is handed over from a lower to a higher frequency band, the numerology difference (e.g. the difference in TTI/time slot length) between the two carrier frequencies prevents the wireless device from deriving the fine time slot estimation for the higher frequency carrier, even if the timing of the transmissions on the two carrier frequencies is derived from the same clock in the same access node. In the combined inter-access node and inter-frequency band case these two inaccuracy sources combine.

To address this problem a non-published internal reference implementation proposes that the network includes/encodes, in the reference signal of each of the beams in a sweep, a time indication that indicates to the wireless device when to send the uplink signal (e.g. USS) to report the result of the beam sweep measurement. In one embodiment of a non-published internal reference implementation the time indication is an integer (possibly implicitly encoded, e.g. through preconfigured mapping between beam reference signals and integer values) indicating the number of OFDM symbols until the time when additional downlink transmission and/or uplink signal should occur. For example, if one beam (direction) is transmitted in each OFDM symbol, the time-indication number in each successive beam would be one smaller than in the previous beam, and could therefore be referred to as a countdown indicator or countdown field.

The solution of the non-published internal reference implementation also comprises several embodiments describing details of how the time indication can be efficiently encoded by a reference signal, e.g. MRS or BRS, transmitted in a beam. In particular, a method is proposed in which there is a predefined mapping from reference signal index to time indicator, i.e. by detecting which reference signal out of the set of predefined possible reference signals that was transmitted, the receiver can infer a value for the time indication. A wireless device is configured with information that allows it to perform this mapping between reference signal and time indication. A wireless device may be configured through dedicated RRC (or other protocol such as Medium Access Control, MAC) signaling or broadcast system information or may be hardcoded/preconfigured with the information based on subscription related data or standard specifications.

Hence, a conclusion is that in future mobile communication systems, it might be the case that each beam in a beam sweep will have to comprise some kind of unique identifier. Either an identity of the beam itself and/or a time indicator defining a time when the wireless device should listen to further information or respond to the beam sweep e.g. by beam reporting.

In a general handover situation between two downlink beams, which target downlink beam to be activated by the network may be quite uncertain. As a result, the beam sweep employed to enable identification of the most suitable target downlink beam may contain a significant number of beams. In addition, if the wireless device uses receive beamforming, the wireless device has to try multiple receive beams for each candidate downlink beam. As a consequence, if the wireless device uses analog receive beamforming, each candidate downlink beam has to be repeated a number of times equal to the number of receive beams the wireless device has to try.

When the countdown, or response time indication scheme is applied in such a scenario, not only each candidate downlink beam, but also each individual repetition of a candidate downlink beam, has to have a unique reference signal, e.g. MRS or BRS, since the countdown or time indication is identified through a reference signal sequence.

Hence, when many candidate downlink beams have to be tried and the wireless device in addition has to try several receive beams using analog receive beamforming, the number of unique reference signals, e.g. MRSs or BRSs, which have to be used for the candidate downlink beam sweep (i.e. including each repetition of each candidate downlink beam) may be large.

The actual number of downlink beam directions that may be included in a sweep depends on several factors, e.g. the number of antennas at the access node, the number of antennas at the wireless device, the deployment density of the access nodes, the number of access nodes that may reach the wireless device with beam transmissions, and (in the handover case) the uncertainty of the wireless device position and which downlink beams to activate. In unfavorable cases, these aspects may combine in a way which results in very many downlink beam reference signal transmissions when beam repetition and time indications are used. If no time indications are used, the number can be substantially lower (divided by the number of repetitions of each downlink beam), but the required unique reference signals may still amount to a substantial number.

This potentially great number of required unique reference signals becomes a problem, because the space of reference signal sequences with sufficiently good autocorrelation and cross-correlation properties is limited. To some extent, this may be compensated for by using longer reference signal sequences at the expense of larger bandwidth. But utilizing larger bandwidth for the reference signal consumes more radio resources, increases interference, imposes higher computational complexity and memory demands (buffer capacity) in the wireless device and can limit the introduction of 5G use cases relying on low complexity terminals (typically requiring smaller bandwidths). In addition, more reference signals to search for (i.e. try to decode) increases the processing burden for the wireless device and degrades detection performance.

The proposed technique will now be described with regards to an access node implementing the above described countdown, or response time indication scheme as an example. Hence, in this example the identity to be provided to the wireless device is a time slot to send the response with the feedback from the measurements. This may in practice also identify the beam itself, e.g. if the wireless device reports the (full) value of the countdown indicator, this identifies the beam to the network.

In this example it is assumed that this handover is controlled by a controlling entity, e.g. a serving access node or a more central entity like a cluster head, a Centralized RAN (C-RAN), a centralized Baseband unit or a Master eNB. Note that establishing a connection (also denoted connectivity leg) to an access node in addition to one or more already existing connections (also denoted connectivity legs) to other access node(s), i.e. multi-connectivity, is in this context considered to be a special case of handover which is covered by the addressed scenarios.

In the example is further assumed that the wireless device has a bi-directional RRC connection directly or indirectly with this controlling entity, which can be used to transmit data related to the handover (among other control signaling data). Again, in the addressed scenarios it is further assumed that this RRC connection is established on a lower carrier frequency and/or to another access node than a number of the candidate downlink beams. Also note that even though RRC signaling may be a, possibly preferred, protocol for the related control signaling between the wireless device and the controlling entity, there are also other alternatives, such as using MAC signaling.

That is, there are essentially three scenarios, in which the invention is beneficial:
The RRC connection is established on a lower carrier frequency than the candidate downlink beams, but to the same access node, i.e. the access node that transmits the candidate downlink beams (i.e. the same access node serves both carrier frequencies). (Note that the lower carrier frequency may be a different RAN, e.g. LTE).
The RRC connection is established on a lower carrier frequency than the candidate downlink beams and to another access node than the access node(s) that transmit(s) the candidate downlink beams. (Note that the lower carrier frequency may be a different RAN, e.g. LTE).
The RRC connection is established on the same carrier frequency as the candidate downlink beams, but to another access node than the access node(s) that transmit(s) the candidate downlink beams.

The proposed technique leverages the fact that a wireless device, due to its synchronization with the serving/source access node, typically can receive/derive coarse time information from the serving/source access node (or other controller node) and/or a lower frequency layer to enable efficient reuse of the same limited number of reference signal sequences in a sweep of candidate downlink beams. This is achieved by matching the reference signal sequence reuse period with the accuracy (and the resulting inaccuracy interval) of the wireless device's coarse time information and by combining the coarse time of a beam reception, as measured by the wireless device, with the information associated with the reference signal sequence of the beam (i.e. beam identification and optionally a report time indication).

Note that the different carrier frequencies of the same access node may be reasonably well synchronized. However, the difference in carrier frequency, and the difference in time resolution that follows from this, implies that timing derived from the lower carrier frequency will be less accurate and/or possibly with a different granularity (e.g. in the case the carrier is configured with a different numerology, e.g. different TTI/time slot length) than the corresponding timing derivation from the higher frequency carrier. The situation is in some sense similar in the case of different access nodes using the same carrier frequency. The two access nodes can only be assumed to be roughly synchronized (in relation to the timing accuracy of a high frequency carrier), where the accuracy depends on the synchronization method and the properties of the backhaul transport network (in case the backhaul transport network is used as a vehicle for the inter-access node synchronization) and/or the inter-access node distance. Good synchronization accuracy can be achieved with Global Navigation Satellite System (GNSS) based synchronization, e.g. using GPS or Galileo, but in this context, availability of such synchronization means cannot be assumed, especially since the high frequency access nodes may often be deployed indoors, where the GNSS coverage is poor or non-existent.

In other words, to counteract the above described need for excessively many unique reference signals, it is proposed to utilize the coarse timing that can be derived from the already established access node connection, i.e. the one which carries the RRC connection, and the wireless device's synchronization with this access node (i.e. the serving access node).

However, the coarse timing is not enough to allow the wireless device to determine precise time slots, e.g. for candidate beam reception or USS transmission, associated with a candidate access node or frequency band. Its inaccuracy depends on the inaccuracy of the inter-access node synchronization and/or numerology differences between frequency bands (e.g. differences in time slot/TTI lengths). This inaccuracy is typically determined by the synchronization mechanism that is used in the network (e.g. network based clock distribution, mutual inter-node synchronization signaling, GNSS based synchronization) and thus regarded as fixed and known through configuration, but more dynamic ways of acquiring the inaccuracy information are also possible, such as inter-node exchange of timing information or timing measurement reports from wireless devices.

This could e.g. be implemented by letting the controlling entity, e.g. the serving/source access node, and the wireless device utilize the coarse timing in the beam sweep procedure as follows.

When configuring the wireless device for measurement of the above described beam sweep in preparation for a handover procedure (i.e. a beam-based mobility procedure), the controlling entity, e.g. the serving/source access node, informs the wireless device of the time to send the response with the feedback from the measurements. This time information has the coarse accuracy that can be achieved according to the above assumptions. For instance, if the full accuracy time indication requires N bits, the coarse time indication may consist of M bits, where M=N−D, where D<N. Hence, there are a minimum of 2^{D} full accuracy time intervals/units for each coarse accuracy time interval/unit. In practice, it may be preferable to have some margin, if there is some uncertainty in the inaccuracy of the coarse timing, and perform the above calculation with an assumed inaccuracy that is somewhat greater than the actually expected inaccuracy. There will then be 2^{D} full accuracy time units for each assumed coarse accuracy (i.e. the assumed slightly overestimated inaccuracy) time unit.

FIG. 3 illustrates how a timeline, from the start of the candidate downlink beam sweep to the time the wireless device should respond, can be divided into full accuracy and coarse accuracy intervals/units. Each full accuracy interval/unit represents a time slot within a coarse accuracy interval, in which a candidate downlink beam may be transmitted. In FIG. 3 the timeline is divided into reuse periods (i.e. coarse accuracy intervals/units) with 8 time slots (i.e. accurate time indications) within each reuse period.

In the example of FIG. 3, the wireless device records a coarse time, t_{coarse}, with the accuracy of the inaccuracy interval, I_{inacc}, for a received beam. The time indication associated with the received beam tells the wireless device the position in the inaccuracy interval. For instance, if the received time indication is 2, the wireless device knows that the received beam is the beam in time slot 2 in reuse interval (or period) 2. This allows the wireless device to derive the exact response time and the wireless device may also report this beam data to the network.

Since the wireless device can keep track of the coarse time itself, the countdown or response time indication represented by the reference signal (i.e. the time indication implicitly encoded in the reference signal) only has to add the accurate timing within the scope of a coarse accuracy interval/unit, thus providing a complete time indication with full accuracy when combined with the coarse time indication.

### Example Operations

The proposed methods will now be described in more detail referring to FIGS. 4 and 5. It should be appreciated that FIGS. 4 and 5 comprise some operations and modules which are illustrated with a solid border and some operations and modules which are illustrated with a dashed border. The operations and modules which are illustrated with solid border are operations which are comprised in the broadest example embodiment. The operations and modules which are illustrated with dashed border are example embodiments which may be comprised in, or a part of, or are further embodiments which may be taken in addition to the operations and modules of the broader example embodiments. It should be appreciated that the operations do not need to be performed in order. Furthermore, it should be appreciated that not all of the operations need to be performed. The example operations may be performed in any order and in any combination.

FIG. 4 illustrates a method, performed in a wireless device, for obtaining an identity. In other words, it is a method in a wireless device for identifying something, such as a time. Thus, the “something” to be identified would then be regarded as having an identity, which could be obtained or discovered. The method is typically performed when the network wants to provide one specific identity, from a set of possible identities, to a wireless device. The specific or unique identity is then indicated by a particular reference signal.

In general, the concept could be used for any identity. However, the examples described herein are mainly directed to an identity associated with any one or more of; a beam, a beam direction, a reception time and/or a transmission time. The transmission/reception time could be associated with the time of transmission/reception of the beam, e.g. within the reuse period or alternatively it could be associated with the time to transmit the response to the reference signal (e.g. an explicit or implicit (through preconfigured reference signal-to-time indication association) indication of the number of time slots (e.g. OFDM symbols) until the time slot for transmission of the response. Hence, according to some aspects a full fine-resolution time would map to the identity to be obtained. However, the unique identity might be determined without an intermediate determination of the full fine-resolution time.

The method comprises receiving S11 a reference signal. Using the example scenario with the candidate target beam, this step implies that the wireless device detects a reference signal transmitted by a radio network node being e.g. a synchronization signal or sequence, from one of the beams in the sweep. This is typically done by comparing (e.g. using a correlation filter) the received radio signal with a set of possible sequences until a match is found.

The reference signal could be a synchronisation signal comprising a symbol sequence. Symbol sequences here refer to detectable signals, having good autocorrelation and cross-correlation properties. Hence, a symbol sequence cannot really be seen as a piece of data in the form of bits, but is rather a signal having certain properties. The symbol sequence can be used to “encode” (or identify) something (e.g. a radio link) by mapping a symbol sequence to a certain “something” (e.g. a selected radio link). One example of a symbol sequence is the Uplink Synchronisation Sequence, USS, described above, which represents a selected beam. However, unique symbol sequences are not crucial. An alternative is letting the time and/or frequency of the symbol sequences transmission serve as a means to identify something (instead of the symbol sequences itself).

The symbol sequences are picked out of a set of sequences with the special properties of being “almost orthogonal”, which implies that a receiving network node can detect one of the symbol sequences and with a certain probability determine which symbol sequence it has detected. Hence, a set of constituent symbol sequences here refers to a set of one or more unique symbol sequences. Hence, all the symbol sequences within the set are unique with respect to one another.

The method further comprises estimating S12 a reception time of the received reference signal. In other words, the wireless device uses the coarse timing of the wireless device. The coarse timing is e.g. the timing used for an already existing RRC connection as described in the example scenario. Hence, the estimated reception is not an exact time, but rather an unprecise time which is or less exact than an exact reception time. In the scenario where the identity to be obtained is mapped to an exact time, the coarse time could then cover several different possible identities.

The method further comprises obtaining S13, identity information based on the received reference signal, wherein the identity information in combination with the estimated reception time indicates the identity. In other words, the wireless device determines identity information (i.e. partial identity information), e.g. representing a fine time component of the coarse reception time, based on the detected reference signal. Note that, even if in the examples herein the identity or the estimated reception time corresponds to respective integer number of bits, this is not a requirement.

According to some aspects, the identity information is encoded into the reference signal. Then the obtaining comprises decoding the reference signal. Encoded or “Implicitly encoded” means that a wireless device is configured with information that maps each reference signal sequence in a sweep to a certain granular time indication (or order number which can be translated into a time indication based on time slots). In other words, the wireless device monitors the spectrum for several dissimilar reference signals, and wherein each of the dissimilar reference signals is mapped to a (partial) identity. Dissimilar implies sequences being almost orthogonal or sufficiently different for effective separation in a receiver. Hence, with this method, there is no explicit time indication in the reference signal sequence. A wireless device may be configured with mapping information through dedicated RRC signaling or broadcast system information or may be hardcoded/preconfigured with the information based on subscription related data or standard specifications.

The identity information is partial because it does not alone specify the unique identity. For example each reference signal in a set of possible reference signals is mapped to one particular partial identity. The partial identity could e.g. be an index between 1 and 10.

The identity information typically represents a higher resolution of the unique identity than the estimated reception time. For example the estimated reception time indicates a particular reuse period and the identity information identifies one particular slot in that reuse period. The reuse period is the period with which the fine time components to be conveyed by reference signal of the beams in the sweep are reused. In other words, according to some aspects, the identity information specifies a time within a reuse period, wherein the time indicates when within the reuse period the respective reference signal was transmitted.

The wireless device is typically aware about the reuse period. The duration and start (or stop) of the reuse period is either predefined or signaled to the wireless device. Hence, according to some aspects, the method comprises obtaining S10 a duration of the reuse period. Hence, the wireless device can use this information and its coarse synchronization with the candidate access node/frequency (based on the synchronization with the serving/source access node/frequency) to derive the particular reuse period in which a beam was received (i.e. a reference signal sequence was detected).

Hence, by combining the particular reuse period (i.e. derived from a coarse time component) with the fine-resolution time indication (i.e. a fine time component) conveyed by the reference signal, the wireless device can derive a full fine-resolution time indication, which may be used e.g. to derive a precise time for uplink signal (e.g. USS) based reporting and which may also be used as a beam reference in the report.

In the example where the identity to be obtained is a full fine-resolution time, the full fine-resolution time indication can be seen as consisting of two components: a coarse time component, represented by the reuse period (e.g. the reuse period number compared to a reference time), and a fine time component, represented by the fine-resolution time indication conveyed by the reference signal sequence. Note that the fine-resolution time indication (i.e. the fine time component) conveyed by the reference signal sequence in a beam only has to be unique within the reuse period. The fine-resolution time indications therefore need to cover a smaller set of possible timing values, compared to providing full fine-resolution timing info via the reference signal transmissions. With one to one mapping between fine-resolution time indication and reference signal sequence, this means that the required number of unique reference signal sequence to form a complete beam sweep is equally reduced.

In one example embodiment the wireless device uses the received reference signal to calculate a unique or exact identity represented by a fine time component (i.e. a full accuracy time indication) and the estimated reception time. Hence, the received identity information is as such not an exact identity (e.g. a time slot), but rather a partial identity information (e.g. a sub frame index) of a more exact identity information (e.g. a time slot). However, when combined with estimated reception time (e.g. a frame) obtained in step S12, the exact identity can be determined.

The information carried by the two identity components i.e. the estimated reception time and the identity information may of course also be structured in any other way using a predetermined rule known to both the receiver and the transmitter side. The idea is basically that the two components together define the identity to be provided. Hence, the number of unique reference signals needed is decreased.

According to some aspects the method comprises reporting S15a the indicated identity to a network node. In other words, the wireless device reports the unique identity indicated by the identity information, which has been determined based on the obtained identity to a network node, e.g. to the network node that initiated the transmission of the reference signal.

Hence, according to some aspects, the provided identity is determined in the wireless device. In order to determine the provided identity the wireless device typically in addition to the estimated reporting time needs to know the duration of the reuse period for the fine time component. Hence, according to some aspects, the method comprises obtaining S10 the duration of the reuse period. This mapping could be received form the network, but could also be conveyed to the wireless device in other ways, e.g. as static (or semi-static) configuration in the system information or even as hardcoding in the wireless device based on a standardized mapping configuration.

If the unique identity is a fine time component as discussed above, the wireless device also needs to know the reference signal to fine time component mapping. This means that when the reference signals used in the beam sweep are reused with the same periodicity, each full accuracy time indication within the inaccuracy period maps to a certain reference signal.

Hence, according to some aspects, the method comprises determining S14 the identity based on identity information, the estimated reception time and the obtained reuse period. In other words, the wireless device determines the full fine-resolution timing (which indicates the reporting time with full accuracy, e.g. the number of time slots until the reporting time) by combining the reuse period number with the fine time component. The wireless device can determine the reuse period number based on its coarse synchronization which provides a timing accuracy equal to or (preferably) slightly more accurate than the reuse period (see further below). The coarse synchronization is based on the synchronization that the wireless device has with the serving/source access node/frequency.

Alternatively, the unique identity is determined in the network. Then, the method comprises reporting the S15b the identity information and the estimated reception time to a network node. This will be further described in connection with the network node below.

According to some aspects, the identity is an identity associated with a time such as a reception time or a transmission time. The unique identity could e.g. define a course time of the transmission of the reference signal.

Note that in all the above example scenarios the inter-access node synchronization inaccuracy and/or the difference in numerology (e.g. difference in TTI/time slot length) between the carrier frequencies prevents the controlling entity, e.g. the serving/source AN, from configuring a time for responding (e.g. USS reporting time) to the reference signal in the wireless devices and therefore it is assumed that time indications are included in the reference signals used in the beam sweep. Hence, the wireless device typically needs to know a time window for the beam sweep, information about how to map a certain received downlink beam to an uplink signal (e.g. USS) and/or other configuration information. To solve this, according to some aspects, the identity indicated by the reference signal defines a time for responding to the reference signal. The response could e.g. be specified in terms of symbols after receiving the reference signal (implicit), or as an absolute time (explicit).

In other words, this disclosure focuses on the case of uplink signal based, e.g. USS based, reporting with time indications implicitly encoded in the reference signals of the downlink beams in the sweep. However, the solution is applicable also for the case of RRC based reporting without time indications encoded in the reference signals. “Implicitly encoded” means that a wireless device is configured with information that maps each reference signal sequence in a sweep to a certain time indication (or order number which can be translated into a time indication based on time slot). Hence, with this method, there is no explicit time indication in the reference signal sequence. A wireless device may be configured through dedicated RRC signalling or broadcast system information or may be hardcoded/preconfigured with the information based on subscription related data or standard specifications.

According to some aspects the identity is an identity associated with a time and the method comprises performing S16 a transceiver operation at the time defined by the identity. An example of a transceiver operation is transmitting an USS sequence.

Further details of the example scenario presented above, will now be described in further detail. In this example every full fine-resolution time is mapped to one beam or Measurement Reference Signal, MRS. By implementing the proposed concept, the same set of accurate time indications with limited scope are allowed to be reused with a period, i.e. a reuse period, which is equal to or greater than the inaccuracy interval (e.g. ±Δ, i.e. an inaccuracy interval of the coarse time indication of I_{inacc}=2Δ). To provide some margin, the reuse period, Pᵣₑᵤₛₑ, could be set to Pᵣₑᵤₛₑ=k×I_{inacc}, where k>1, e.g. k=1.25 (as assumed in the example of FIG. 3). The reuse period would thus represent the above mentioned slightly overestimated inaccuracy.

With this scheme the countdown or time indication represented by the reference signal only has to provide the accuracy that is still missing when the reuse period is identified, i.e.,

t_{ind}=t_{acc} modulo Pᵣₑᵤₛₑ,

where t_{ind} is the indicated full accuracy time within the reuse period, t_{acc} is the full accuracy time and Pᵣₑᵤₛₑ is (the length of) the reuse period. This means that t_{ind} only requires D bits. As mentioned above, these D bits may be reused in each reuse period, since the coarse timing is enough to distinguish between two reuse periods and thus between two sets of reused bits. As a result, a complete candidate downlink beam sweep can be transmitted using only 2° unique reference signals. However, since perfect coordination between different candidate access nodes cannot be assumed, given the limited synchronization, if multiple candidate access nodes are involved in a beam sweep, each candidate access node may have to use its own reference signals in its own (partial) sweep of candidate downlink beams. Therefore, the number of required unique reference signals in a sweep may be 2^{D}×A, where A is the number of candidate access nodes.

This number of required unique reference signals may be only a small fraction of the number of beam transmissions in a long candidate downlink beam sweep, thereby greatly simplifying the effort of finding good enough reference signals and, by limiting the number of required unique such reference signals, their properties (e.g. in terms of autocorrelation and cross-correlation) may be improved. Requiring fewer unique reference signals also facilitates coordination of reuse of the reference signals among different access nodes and areas.

Now turning back to the timeline of FIG. 3. In FIG. 3 the full accuracy time intervals/units are numbered backwards from the response time they indicate and since the accurate time indication, t_{ind}, only indicates t_{ind}=t_{acc} modulo Pᵣₑᵤₛₑ, these indications are repeated with a period of a coarse time interval/unit represented by Pᵣₑᵤₛₑ. Similarly, the repetition/reuse periods are also numbered backwards from the response time (but without repetition).

When the wireless device is configured to measure on a sweep of candidate downlink beams, it starts (at the time when the beam sweep is to start, or slightly before to have some margin) to try its receive beams one by one, repeating its set of receive beams over and over until the time of reporting or for as long as it has been configured to keep measuring. When the wireless device has concluded the measurements, it determines which of the received candidate downlink beams was the best and reports it to the network at the indicated response time. The wireless device derives the indicated response time with full accuracy as follows:

When receiving a certain candidate downlink beam, the wireless device measures the time of reception (representing the time remaining to the response time), t_{coarse}. This gives the wireless device rough information of where on the timeline the received candidate downlink beam is located, i.e. within the inaccuracy interval, I_{inacc}=t_{coarse}±Δ. The accurate time indication associated with the received candidate downlink beam now tells the wireless device exactly where in the inaccuracy interval the received candidate downlink beam is located, which allows the wireless device to derive the time slot and reuse period the candidate downlink beam was received in. This data in turn allows the wireless device to derive the exact response time. If the wireless device in the example of FIG. 3, for instance, receives the time indication 2, the wireless device knows that it has received the candidate downlink beam in time slot 2 in reuse period 2. Since the reuse period in the example of FIG. 3 is 8 time slots, the wireless device can calculate that the time remaining to the response time is exactly 2×8+2=18 time slots.

A corresponding method, performed in a network node in a wireless communication network, for providing an identity, to one or more wireless devices, will now be described referring to FIG. 5. The method is performed either at connection setup or when a wireless device is already connected to the network node. The network node is e.g. an access node. The method is e.g. performed in connection with a beam sweep, when the network node is about to transmit a measurement signal (e.g. reference signals) on a plurality of candidate radio links (e.g. beams). Then each beam direction could correspond to one unique identity.

The network node is the node in the communication network that controls the beam sweep. The beam sweep could be controlled by the currently serving access node, the source serving access node or a candidate access node or a combination thereof. However, the herein referred network node would then be the node that allocates reference signals, as will be further described below. In other words, the network node is e.g. the currently serving access node, the source serving access node or a candidate access node. The network node could also be a controller node, e.g. controlling both the serving/source and the candidate access node.

As discussed above the provided identity (e.g. a beam or reference signal) is e.g. mapped to a particular time slot. The particular time slot could be estimated by deriving a course time and a granular time. The main concept of the disclosure is independent from the format of the identity. Hence, according to some aspects, the identity is any one or more of an identity of a beam, a beam direction a transmission time and/or a reception time. One particular example is an identity of a time slot, where a response to the reference signal should be transmitted.

The method comprises determining S2 one or more reference signals, such that each reference signal indicates identity information. The identity information or partial identity information e.g. corresponds to the granular time component needed to determine an exact time of a time slot being mapped to the provided identity. Hence, each reference signal in combination with an estimated reception time of the reference signal, enables determination of the identity in a receiving wireless device. The estimated reception time would then represent a coarse time component of the time slot mapped to the provided identity. Hence, the estimated reception is not an exact time. In the scenario where the identity to be obtained is mapped to an exact time, the coarse time could then cover several different possible identities. One of those is identified by the identity information.

In other words, the network node determines the fine time components, i.e. the full accuracy time indications to be conveyed by the reference signals in the sweep. The number of different fine time components, and thus the number of different reference signals, should match the length of a reuse period of the fine time components. This could be done jointly by the serving/source access node and the candidate access node or solely by the candidate access node (and conveyed to the serving/source access node) or solely by the serving/source access node (and conveyed to the candidate access node) or by a controller node, e.g. controlling both the serving/source and the candidate access node.

The network node then selects the reference signals (e.g. symbol sequences) to be used to convey the fine time components (i.e. the full accuracy time indications) in the beam sweep. This e.g. includes determining a mapping between symbol sequences and fine time components.

In other words, according to some aspects, the reference signals are transmitted in different directions. According to some aspects, the signals constitute one or more beam sweeps. The sets of beams from different candidate node may be considered as a separate beam sweep. Sometimes the candidate nodes are not coordinated into a single beam sweep, but effectively perform separate beam sweeps. According to some aspects, the candidate nodes are coordinated such that their beams are transmitted so that they together form a single beam sweep.

Then the selected symbol sequences are transmitted from the candidate access node in consecutive beams (with a reuse period—see further below) to form a beam sweep. In other words, the method comprises initiating S3 transmission of the reference signals to the one or more wireless devices, at different points in time. The node transmitting the sequences does not need to be the same node as the node determining the sequences. Hence, the source access node may determine the synchronization sequences and one or more candidate node(s) may transmit them.

The network then typically receives an uplink signal from the wireless device, constituting the report of the result of the beam sweep, i.e. the indication of the beam the wireless device perceived as the best. This uplink signal would typically be sent to the candidate node that transmitted the selected (i.e. best) beam, but variations where the wireless device transmits the uplink signal to the serving/source access node are conceivable.

As mentioned above, the time indication would match a reuse period. The reuse period is defined as a period of time, wherein the time indications are dissimilar. Hence, according to some aspects the method comprises obtaining S0 a reuse period of reference signals indicating identity information. In other words, in each new reuse period, the reference signals of the previous reuse period may be reused. Consequently, according to some aspects, at least two of the reference signals that are transmitted in different reuse periods comprise the same identity information.

The length of the reuse period is dependent on how accurate the coarse time estimate is. If the coarse time estimate is accurate a short reuse period could be used. With a short reuse period the number of dissimilar reference signals is decreased, which would in turn decrease processing load and delay, as fewer unique sequences needs to be monitored.

In a communication system, the wireless device timing uncertainty in relation to the candidate access node/frequency may be estimated, e.g. based on a known timing uncertainty between the serving/source access node/frequency (with which the wireless device is well synchronized) and the candidate access node/frequency. This uncertainty could be configured in the network (e.g. a maximum uncertainty value) or it could be estimated based on inter-access node backhaul communication, inter-access node radio interface monitoring (i.e. listening to each other's transmissions) and/or, in the inter-frequency case, the difference in numerology (e.g. difference in TTI/time slot length).

Typically, the network node obtains the timing inaccuracy between the serving node frequency and the candidate node frequency, adapts the reuse period of the reference signal sequences and informs the wireless device about the reuse period and a time reference (typically a reporting time for uplink signal (e.g. USS) based reporting). Hence, according to some aspects the method comprises providing S1 a value indicating the reuse period to the one or more wireless devices. According to some aspects, the reuse period is associated with an uncertainty of the correctness of the estimated reception time.

Alternatively a fixed reuse period may be used, or the reuse period could be calculated based on other parameters side information parameters. A fixed reuse period needs to be suitable for a “worst case scenario”. For example a previously used reuse period could be used. Then no signaling of the reuse period is needed.

The identity information typically specifies a time within a reuse period. The time indicates when within the reuse period the respective reference signal is going to be transmitted, as described in the example of FIG. 3.

In the example scenario with the beam sweep, the network also determines the reporting time, i.e. the time when the wireless device should send the uplink signal, e.g. USS, to report the result of the beam sweep measurement procedure. This determination may be an inter-access node task, i.e. involving both the serving/source access node and the candidate access node, but the determination could also be made solely by the candidate access node (and conveyed to the serving/source access node) or solely by the serving/source access node (and conveyed to the candidate access node) or by a controller node, e.g. controlling both the serving/source and the candidate access node.

The determined reporting time is signaled from the serving/source access node (possibly forwarded from a controller node) to the wireless device together with other information related to the beam sweep. This other information includes MRS sequence to fine time component mapping and the reuse period (i.e. the period with which the fine time components, i.e. the full accuracy time indications, to be conveyed by the MRS sequences of the beams in the sweep are reused—see further below) and possibly a time window for the beam sweep, information about how to map a certain received downlink beam to an uplink signal (e.g. USS) and/or other configuration information.

This mapping could also be conveyed to the wireless device in other ways, e.g. as static (or semi-static) configuration in the system information or even as hardcoding in the wireless device based on a standardized mapping configuration.

Note that this means that the MRS sequences used in the beam sweep are reused with the same period, each full accuracy time indication maps to a certain MRS sequence.

Hence, according to some aspects, the obtained identity information indicates a reserved time slot where the wireless device is allowed to transmit and/or can expect to receive further transmissions from the network node. This could be done implicitly or explicitly. According to some aspects, the identity constitutes a reference to a reserved time slot for responding.

According to some aspects, the reference signals are determined from a set of dissimilar reference signals, and wherein each of the dissimilar reference signals in the set is associated with a respective identity, see above.

### Different Uplink Beam Reporting Scenarios

When beam sweeping is used in conjunction with handover (or any mobility procedure), the wireless device has an active control signaling connection (typically an RRC connection) to its serving access node (or via its serving access node to a controlling entity that is separate from the serving access node). Before a beam sweep in conjunction with handover, the wireless device can be configured via RRC for the beam sweep (e.g. in terms of which reference signals to listen for in the beams, what and how to report the result). As mentioned above, USS based reporting has advantages in conjunction with handover situations, because USS transmission is fast and resource efficient. However, the alternative of using the already existing RRC connection to the source access node (or controlling entity) to report the result of the beam sweep measurement also has advantages, e.g. that more nuanced measurement reports may be conveyed), and is therefore a valid option (USS based and RRC based reporting may be two options that an operator may choose from when configuring the network). When RRC based reporting is used, no time indication is required in the beams in the sweep, but the wireless device can simply use any regular means for uplink scheduling request and then transmit its beam sweep measurement result report in an RRC message. This result report would typically contain an indication of the best beam, potentially also other lower ranked beams and optionally also channel quality indication(s) for the reported beam(s).

With the above described uplink signal (e.g. USS) based reporting, the wireless device would, as part of the configuration for the candidate downlink beam sweep, be configured with one uplink signal (e.g. USS) sequence for each of the downlink beams in the sweep. In other words, there would be a one to one mapping between the beams and the uplink signal, e.g. USS, sequences. More precisely, such a mapping could be formed between each combination of reuse period and time indication, so that each potential beam transmission time slot can be reported. At the indicated reporting time, the wireless device will transmit the uplink signal, e.g. USS, which maps on the downlink beam that the wireless device perceived as the best in the sweep.

With RRC based reporting in conjunction with handover the wireless device can identify the selected candidate downlink beam in the report to the network using an indication of the beam's reference signal, e.g. an index together with an indication of the reuse period the beam was received in. An alternative could be that the wireless device identifies the selected downlink beam in the report using the combination of the repetition/reuse period number and the received time indication (i.e. t_{ind}). As yet another alternative the wireless device may use the derived repetition/reuse period number and the received time indication to calculate the complete full accuracy time of the reception and report this to the network. Yet another alternative is that the wireless device reports the coarse accuracy time it has measured and the received time indication. Then the network, knowing the reuse period of the time indications and the inaccuracy interval of the wireless device's coarse timing, can identify which candidate downlink beam that transmitted the time indication that the wireless device reported.

### Determining and Signaling the Timing Uncertainty

In general, the beam sweep configuration, including e.g. how many and which candidate beams to be activated, which MRSs to use and how to reuse them (e.g. the reuse period) is determined by the network, involving any combination of a dedicated controlling entity (if any), such as a cluster head or Master eNB, the serving access node and the candidate access node(s). How the tasks are divided between the involved entity/entities is outside the scope of this invention disclosure.

Irrespective of how which entity/entities that is/are responsible, for the solution to be feasible the network has to acquire knowledge, or an estimate, of the timing inaccuracy that can be expected between the wireless device and a candidate access node (with regards to the downlink synchronization). In a handover situation the wireless device is connected to, and synchronized with, the serving access node. Hence, the timing inaccuracy between the serving access node and the candidate access node can be used as proxy for the timing inaccuracy between the wireless device and the candidate access node. I.e. the timing inaccuracy between the wireless device and the candidate access node can be estimated as the timing inaccuracy between the serving access node and the candidate access node, possibly with some added margin.

The network can acquire the timing inaccuracy between the serving access node and the candidate access node in several ways, e.g. one or more of the following:
Network nodes, in particular the serving/source access node in this case, could be configured with the timing inaccuracy (e.g. a maximum timing uncertainty value).
Based on timing accuracy reports from previously handed over wireless devices between the same source and target access nodes, e.g. using RRC signaling.
Estimated based on inter-access node backhaul communication.
Based on inter-access node radio interface monitoring (i.e. neighbor access nodes listen to each other's transmissions).
Signaling from a central controller that has that timing information for the different access nodes.
Based on the serving/source access node's (or controller node's) knowledge of the current timing source for the wireless device and the quality of alignment of that source's timing with the access node's timing.
In the inter-frequency case it could be based on the difference in numerology (e.g. difference in TTI/time slot length) between the serving/source and candidate frequency bands.

The network also signals to the wireless device the assumed uncertainty period (or rather a slightly overestimated uncertainty period in the form of the reuse period (i.e. the period with which the time indications and MRS sequences are reused), so the wireless device can combine the coarse and fine time components to obtain the full fine-resolution timing indication. The signaling may be embedded in the MRS measurement command.

### Example Node Configurations

Turning now to FIG. 6a, which is a schematic diagram that illustrates some modules of an example embodiment of a wireless device being configured for obtaining an identity. The wireless device is configured to implement all aspects of the methods described in relation to FIG. 4.

The wireless device 10 comprises a radio communication interface (i/f) 11 configured for communication with a network node. The radio communication interface 11 may be adapted to communicate over one or several radio access technologies. If several technologies are supported, the node typically comprises several communication interfaces, e.g. one WLAN or Bluetooth communication interface and one cellular communication interface.

The wireless device 10 comprises a controller, CTL, or a processing circuitry 12 that may be constituted by any suitable Central Processing Unit, CPU, microcontroller, Digital Signal Processor, DSP, etc. capable of executing computer program code. The computer program may be stored in a memory, MEM 13. The memory 13 can be any combination of a Read And write Memory, RAM, and a Read Only Memory, ROM. The memory 13 may also comprise persistent storage, which, for example, can be any single one or combination of magnetic memory, optical memory, or solid state memory or even remotely mounted memory. According to some aspects, the disclosure relates to a computer program comprising computer program code which, when executed, causes a wireless device to execute the methods described above and below. According to some aspects the disclosure pertains to a computer program product or a computer readable medium holding said computer program.

The processing circuitry 12 is configured to cause the wireless device 10 to receive a reference signal, to estimate a reception time of the received reference signal and to obtain S13, identity information based on the received reference signal, wherein the identity information in combination with the estimated reception time indicates the identity.

According to some aspects, the identity is an identity associated with any one or more of; a beam, a beam direction, a reception time and/or a transmission time.

According to some aspects, the processing circuitry 12 is configured to cause the wireless device 10 to report the S15a the indicated identity to a network node.

According to some aspects, the identity information specifies a time within a reuse period, wherein the time indicates when within the reuse period the respective reference signal was transmitted.

According to some aspects, the processing circuitry 12 is configured to cause the wireless device 10 to obtain the duration of the reuse period and to determine the identity based on identity information, the estimated reception time and the obtained reuse period.

According to some aspects, the processing circuitry 12 is configured to cause the wireless device 10 to report the S15b the identity information and the estimated reception time to a network node.

According to some aspects, the identity is an identity associated with a time and wherein the processing circuitry 12 is configured to cause the wireless device 10 to perform S16 a transceiver operation at the time defined by the identity.

According to some aspects, the identity information is encoded into the reference signal and wherein the obtaining comprises decoding the reference signal.

According to some aspects, the wireless device monitors the spectrum for several dissimilar reference signals, and wherein each of the dissimilar reference signals is mapped to an identity.

According to some aspects the processing circuitry 12 or the wireless device 10 comprises modules configured to perform the methods described above. The modules are illustrated in FIG. 6b. The modules are implemented in hardware or in software or in a combination thereof. The modules are according to one aspect implemented as a computer program stored in a memory 13 which run on the processing circuitry 12.

According to some aspects the wireless device 10 or the processing circuitry 12 comprises a first obtainer module 120 configured to obtain the duration of a reuse period of a reference signal.

According to some aspects the wireless device 10 or the processing circuitry 12 comprises a receiver module 121 configured to receive a reference signal

According to some aspects the wireless device 10 or the processing circuitry 12 comprises an estimator 122 configured to estimate a reception time of the received reference signal.

According to some aspects the wireless device 10 or the processing circuitry 12 comprises a second obtainer 123 configured to obtain S13, identity information based on the received reference signal, wherein the identity information in combination with the estimated reception time indicates the identity.

According to some aspects the wireless device 10 or the processing circuitry 12 comprises a determiner 124 configured to determine the identity based on partial identity information, the estimated reception time and the obtained reuse period.

According to some aspects the wireless device 10 or the processing circuitry 12 comprises a reporter 125 configured to report the indicated identity or the timing indication and the reception time estimate to a network node.

According to some aspects the wireless device 10 or the processing circuitry 12 comprises a performer 126 perform a transceiver operation at the time defined by the identity.

FIG. 7a illustrates an example of a network node 20, which incorporates some of the example embodiments discussed above. FIG. 7a discloses a network node 20 being configured for providing an identity to one or more receiving wireless devices. Typically, the network node is a base station, but could also be any other controlling network node, e.g. a node controlling both a serving/source and a candidate access node at handover. The network node is e.g. the node in the communication network that controls a beam sweep.

As shown in FIG. 7a, the network node 20 comprises a radio communication interface or radio circuitry 21 configured to receive and transmit any form of communications or control signals within a network. It should be appreciated that the radio circuitry 21 is according to some aspects comprised as any number of transceiving, receiving, and/or transmitting units or circuitry. It should further be appreciated that the radio circuitry 21 can e.g. be in the form of any input/output communications port known in the art. The radio circuitry 21 e.g. comprises RF circuitry and baseband processing circuitry (not shown).

As shown in FIG. 7a, the network node 20 according to some aspects comprises a network communication interface 14. The network communication interface 14 is configured for communication with other wireless devices e.g. in a core network. This communication is often wired e.g. using fiber. However, it may as well be wireless. The network node 20 according to some aspects further comprises at least one memory unit or circuitry 23 that is in communication with the radio circuitry 21. The memory 23 can e.g. be configured to store received or transmitted data and/or executable program instructions. The memory 23 is e.g. configured to store any form of contextual data. The memory 23 can e.g. be any suitable type of computer readable memory and can e.g. be of volatile and/or non-volatile type

The network node 20 further comprises processing circuitry 22 which configured to cause the network node to determine one or more reference signals, such that each reference signal indicates identity information, whereby each reference signal in combination with an estimated reception time of the reference signal, enables determination of the identity; and to initiate transmission of the reference signals to the one or more wireless devices, at different points in time.

The processing circuitry 22 is e.g. any suitable type of computation unit, e.g. a microprocessor, Digital Signal Processor, DSP, Field Programmable Gate Array, FPGA, or Application Specific Integrated Circuit, ASIC, or any other form of circuitry. It should be appreciated that the processing circuitry need not be provided as a single unit but is according to some aspects provided as any number of units or circuitry.

The controller, CTL, or processing circuitry 22 is according to some aspects capable of executing computer program code. The computer program is e.g. stored in a memory, MEM, 13. The memory 13 can be any combination of a Read And write Memory, RAM, and a Read Only Memory, ROM. The memory 13 in some situations also comprise persistent storage, which, for example, can be any single one or combination of magnetic memory, optical memory, or solid state memory or even remotely mounted memory. It should be appreciated that the processing circuitry need not be provided as a single unit but is according to some aspects provided as any number of units or circuitry. According to some aspects, the disclosure relates to a computer program comprising computer program code which, when executed, causes a network node to execute the methods described above and below.

According to some aspects, the identity is any one or more of an identity of a beam, a beam direction, a transmission time and/or a reception time.

According to some aspects, wherein the identity information specifies a time within a reuse period, and wherein the time indicates when within the reuse period the respective reference signal is going to be transmitted.

According to some aspects, the reuse period reflects an uncertainty of the correctness of the estimated reception time.

According to some aspects, at least two of the reference signals that are transmitted in different reuse periods comprise the same identity information.

According to some aspects, the processing circuitry 22 is configured to cause the network node 20 to obtain S0 a reuse period of reference signals indicating identity information.

According to some aspects, the processing circuitry 22 is configured to cause the network node 20 to transmit a value indicating the reuse period to the one or more wireless devices.

According to some aspects, the reference signals are transmitted in different directions.

According to some aspects, the transmission of the reference signals constitutes one or more beam sweeps.

According to some aspects, the identity indicates a reserved time slot where the wireless device is allowed to transmit and/or can expect to receive further transmissions from the network node.

According to some aspects, the processing circuitry 22 is configured to determine the reference signals from a set of dissimilar reference signals, and wherein each of the dissimilar reference signals in the set is associated to a respective identity.

According to some aspects the network node 20 or the processing circuitry 22 comprises modules configured to perform the methods described above. The modules are implemented in hardware or in software or in a combination thereof. The modules are illustrated in FIG. 7b. The modules are according to one aspect implemented as a computer program stored in a memory 23 which run on the processing circuitry 22.

According to some aspects the network node 20 or the processing circuitry 22 comprises an obtainer 220 configured to obtain the duration ofa reuse period ofa reference signals indicating identity information.

According to some aspects the network node 20 or the processing circuitry 22 comprises a provider 221 configured to provide a value indicating the reuse period to the one or more wireless devices.

According to some aspects the network node 20 or the processing circuitry 22 comprises a determiner 222 configured to determine, one or more reference signals, such that each reference signal indicates identity information, whereby each reference signal in combination with an estimated reception time of the reference signal, enables determination of the identity.

According to some aspects the network node 20 or the processing circuitry 22 comprises a transmission initiator 223 configured to initiating transmission of the synchronization sequences to the one or more wireless devices, at different points in time.

Aspects of the disclosure are described with reference to the drawings, e.g., block diagrams and/or flowcharts. It is understood that several entities in the drawings, e.g., blocks of the block diagrams, and also combinations of entities in the drawings, can be implemented by computer program instructions, which instructions can be stored in a computer-readable memory, and also loaded onto a computer or other programmable data processing apparatus. Such computer program instructions can be provided to a processor of a general purpose computer, a special purpose computer and/or other programmable data processing apparatus to produce a machine, such that the instructions, which execute via the processor of the computer and/or other programmable data processing apparatus, create means for implementing the functions/acts specified in the block diagrams and/or flowchart block or blocks.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved. Also, the functions or steps noted in the blocks can according to some aspects of the disclosure be executed continuously in a loop.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

A “wireless device” as the term may be used herein, is to be broadly interpreted to include a radiotelephone having ability for Internet/intranet access, web browser, organizer, calendar, a camera (e.g., video and/or still image camera), a sound recorder (e.g., a microphone), and/or Global Positioning System, GPS, receiver; a Personal Communications System, PCS, user equipment, UE, that according to some aspects combine a cellular radiotelephone with data processing; a Personal Digital Assistant, PDA, that can include a radiotelephone or wireless communication system; a laptop; a camera (e.g., video and/or still image camera) having communication ability; and any other computation or communication device capable of transceiving, such as a personal computer, a home entertainment system, a television, etc.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

The various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that performs particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

1. A method for use in a wireless device, for obtaining an identity, the method comprising:
receiving a reference signal;
estimating a reception time of the received reference signal; and
obtaining identity information based on the received reference signal, the identity information in combination with the estimated reception time indicating the identity.

2. The method of claim 1, wherein the identity is an identity associated with at least one from the group consisting of:
a beam;
a beam direction;
a reception time; and
a transmission time.

3. The method of claim 2, further comprising:
reporting the the indicated identity to a network node.

4. The method of claim 1, wherein the identity information specifies a time within a reuse period, wherein the time indicates when within the reuse period the respective reference signal was transmitted.

5. The method of claim 4, further comprising:
obtaining the duration of the reuse period; and
determining the identity based on the identity information, the estimated reception time and the obtained reuse period.

6. The method of claim 1, further comprising:
reporting the the identity information and the estimated reception time to a network node.

7. The method according to of claim 1, wherein the identity is an identity associated with a time and wherein the method further comprises:
performing a transceiver operation at the time defined by the identity.

8. (canceled)

9. (canceled)

10. A method for use in a network node, for providing an identity, to at least one wireless device, the method comprising:
determining at least one reference signal, such that each reference signal indicates identity information, each reference signal in combination with an estimated reception time of the reference signal enables determination of the identity; and
initiating transmission of the reference signals to the at least one wireless, device at different points in time.

11. The method of claim 10, wherein the identity is at least one from the group consisting of:
a beam;
a beam direction;
a reception time; and
a transmission time.

12. The method of claim 10, wherein the identity information specifies a time within a reuse period, and wherein the time indicates when within the reuse period the respective reference signal is going to be transmitted.

13. The method of claim 10, wherein the reuse period is associated with an uncertainty of the correctness of the estimated reception time.

14. The method of claim 12, wherein at least two of the reference signals that are transmitted in different reuse periods comprise the same identity information.

15. The method of claim 12, further comprising:
obtaining a reuse period of reference signals indicating identity information.

16. The method of claim 12, further comprising:
providing a value indicating the reuse period to the at least one wireless device.

17. The method of claim 12, wherein the reference signals are transmitted in different directions.

18. The method of claim 12, wherein the transmission of the reference signals constitutes at least one beam sweep.

19. (canceled)

20. (canceled)

21. A wireless device configured for obtaining an identity, the wireless device comprising:
a communication interface and
processing circuitry configured to cause the wireless device:
to receive a reference signal;
to estimate a reception time of the received reference signal; and
to obtain identity information based on the received reference signal, the identity information in combination with the estimated reception time indicating the identity.

22. The wireless device of claim 21, wherein the identity is an identity associated with at least one from the group consisting of:
a beam;
a beam direction;
a reception time; and
a transmission time.

23. The wireless device of claim 21, wherein the processing circuitry is configured to cause the wireless device:
to report the indicated identity to a network node.

24. (canceled)

25. (canceled)

26. (canceled)

27. (canceled)

28. (canceled)

29. (canceled)

30. A network node in a communication network configured for providing an identity to at least one wireless device, the network node, comprising:
a communication interface; and
processing circuitry configured to cause the network node:
to determine multiple reference signals, such that each reference signal indicates identity information, each reference signal in combination with an estimated reception time of the reference signal enables determination of the identity; and
to initiate transmission of the reference signals to the at least one wireless device at different points in time.

31-42. (canceled)
